(19) United States
(12) Patent Application Publication
(10) Pub. No.: US 2009/0186529 A1
(43) Pub. Date: Jul. 23, 2009

(54) Powered external serial advanced technology attachment plug

(75) Inventor: Jui-Tu Chiang, Taipei Hsien (TW)

Correspondence Address: ELIZABETH CHIEN-HALE, 40087 MISSION BLVD. BOX 367, FREMONT, CA, 94539, US

(73) Assignee: Taiwin Electronics Co., LTD

(21) Appl. No.: 12/383,328

(22) Filed: Mar. 23, 2009

Related U.S. Application Data
(63) Continuation-in-part of application No. 11/899,311, filed on Sep. 4, 2007.

(51) Int. Cl. H01R 13/02

(52) U.S. Cl. 439/660

(57) ABSTRACT

A powered external serial advanced technology attachment (eSATA) plug has a body, seven eSATA terminals and a dual-purpose terminal assembly. The body has a connecting end and a chamber. The chamber is formed in and through the connecting end of the body and has a first inner surface and a second inner surface opposite to the first inner surface. The eSATA terminals are mounted on and bulge from the first inner surface of the chamber. The dual-purpose terminal assembly is mounted on and bulges from the second inner surface of the chamber and has multiple power and data (P/D) terminals. The P/D terminals are apart from and parallel to one another, and each P/D terminal selectively transmits electrical power and data. The eSATA plug of the present invention provides more functions so the eSATA plug applies to more applications than the conventional SATA plug or socket.

### CROSS REFERENCE

The present application is a continuation-in-part application of the U.S. application Ser. No. 11/899,311 filed on Sep. 4, 2007.

### BACKGROUND OF THE INVENTION

1. Field of the Invention

The present invention relates to an external serial advanced technology (eSATA) plug, and more particularly to an eSATA plug that is capable of selectively transmitting electrical power and data from a socket connected to the eSATA plug.

2. Description of Related Art

Serial advanced technology attachment (SATA) is an interface standard for connecting computers to mass storage devices. External serial advanced technology attachment (eSATA) is an interface standard similar to the SATA standard but especially for external devices. The external devices exchange data with computers through eSATA plugs and sockets with high data transmission speed.

However, neither the SATA nor eSATA standard allows the external devices to obtain electrical power from the computer. Each external device further requires a dedicated power line connecting the external device to a power source, such as a corresponding computer or utility power.

One solution to overcome the above drawback is provided by U.S. patent application with Publication No. 2005/0048846 (hereinafter, Suzuki). With reference to FIG. 8, Suzuki disclosed a conventional plug conforming to SATA standards. The conventional SATA plug comprises a housing (50), multiple SATA data terminals (51) and three power terminals (52). The housing (50) has a front opening (501) and a chamber (502). The chamber (502) is formed in the housing (50) and communicates with the front opening (501) of the housing (50). The chamber (502) has a top inner surface (502a) and a bottom inner surface (502b). The SATA data terminals (51) are mounted on the top inner surface (502a) of the chamber (502) in parallel. The power terminals (52) are mounted on the bottom inner surface (502b) of the chamber (502). When the conventional SATA plug is mounted on an external device and a particular SATA socket having power terminals is mounted on a computer, the external device exchanges data with and obtains electric power from the computer through the conventional SATA plug and the particular SATA socket.

Another solution is provided by U.S. Pat. No. 7,255,607 (hereinafter, Wu). With reference to FIGS. 9 and 10, Wu disclosed a conventional SATA socket comprising a housing (60), a tongue (61), a SATA data terminal assembly (62) and a power terminal assembly (63). The housing (60) has a front opening (601) and a chamber (602). The chamber (602) is formed in the housing (60), communicates with the front opening (601) and has a top inner surface (602a). The tongue (61) is mounted in the chamber (602) and has a top (611). The SATA data terminal assembly (62) is mounted on the top (611) of the tongue (61). The power terminal assembly (63) is mounted on the top inner surface (602a) of the housing (602).

However, both the power terminals (52) in Suzuki and the power terminal assembly (63) in Wu cannot transmit data so the external device cannot exchange extra data with the connected computer over the power terminals (52) or the power terminal assembly (63). An extra plug is required to allow the external device to connect to and exchange extra data with the computer. The extra plug burdens a user with carrying both the eSATA plug and the extra plug.

To overcome the shortcomings, the present invention provides an eSATA plug that is capable of selectively transmitting electrical power and data from a socket connected to the plug to mitigate or obviate the aforementioned problems.

### SUMMARY OF THE INVENTION

The main objective of the invention is to provide an external serial advanced technology (eSATA) plug that is capable of selectively transmitting electrical power and data.

The eSATA plug in accordance with the present invention comprises a body, seven eSATA terminals and a dual-purpose terminal assembly. The body has a connecting end and a chamber. The chamber is formed in and through the connecting end of the body and has a first inner surface and a second inner surface opposite to the first inner surface. The eSATA terminals are mounted on and bulge from the first inner surface of the chamber. The dual-purpose terminal assembly is mounted on and bulges from the second inner surface of the chamber and comprises multiple power and data (P/D) terminals. The P/D terminals are apart from and parallel to one another, and each P/D terminal transmits either electrical power or data. The eSATA plug of the present invention provides more functions so the eSATA plug applies to more applications than the conventional SATA plug or socket.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an external serial advanced technology (eSATA) plug in accordance with the present invention;

FIG. 2 is an exploded view of the eSATA plug in FIG. 1;

FIG. 3 is a front view of the eSATA plug in FIG. 1;

FIG. 4 is a perspective view of the eSATA plug in FIG. 1 and a 2-in-1 socket conforming to eSATA and Universal Serial Bus (USB) standards;

FIG. 5 is a front view in partial section of the eSATA plug and the 2-in-1 socket in FIG. 4 when the eSATA plug is inserted into the 2-in-1 socket;

FIG. 6 is an exploded view of a second embodiment of an eSATA plug in accordance with the present invention;

FIG. 7 is a front view in partial section of the eSATA plug in FIG. 6 and another 2-in-1 socket when the eSATA plug is inserted into the 2-in-1 socket;

FIG. 8 is a front view of a conventional serial advanced technology attachment (SATA) plug;

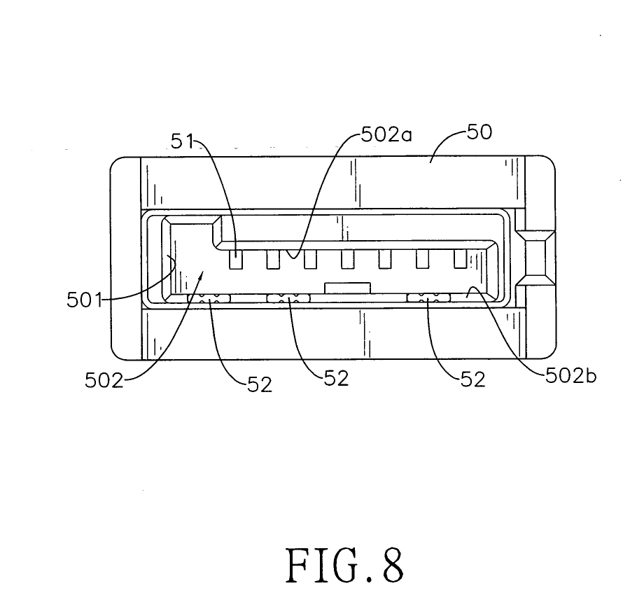

FIG. 9 is a side view in partial section of another conventional SATA socket; and

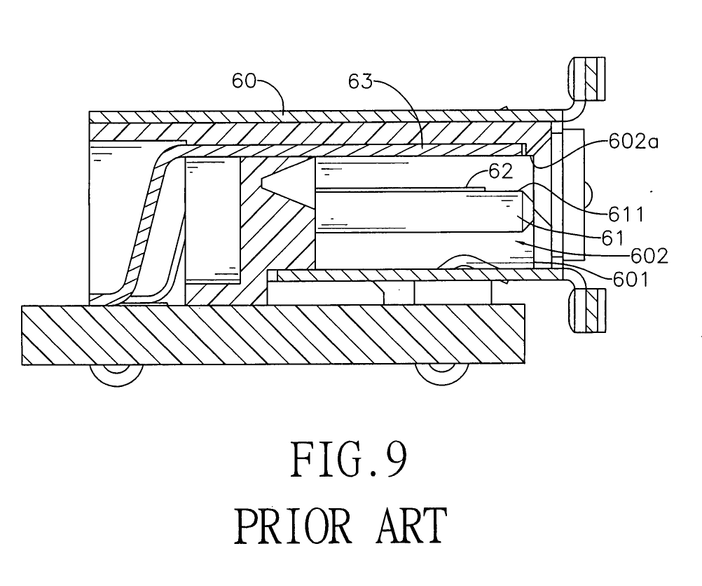

FIG. 10 is a side view in partial section of the conventional SATA socket in FIG. 9.

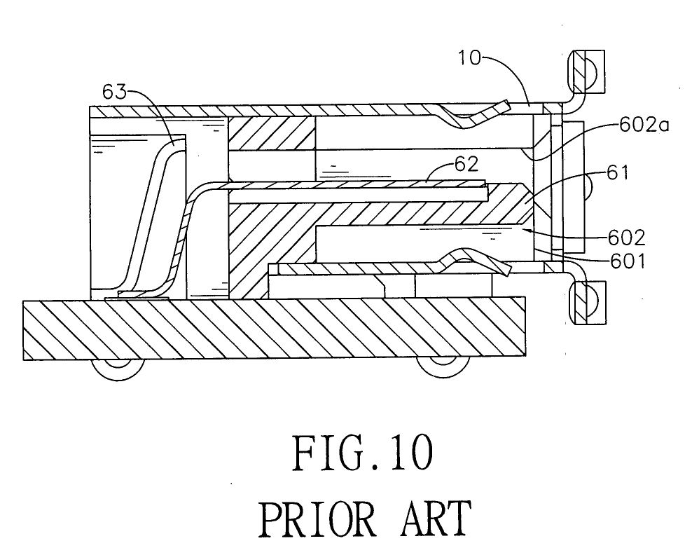

### DETAILED DESCRIPTION OF PREFERRED EMBODIMENT

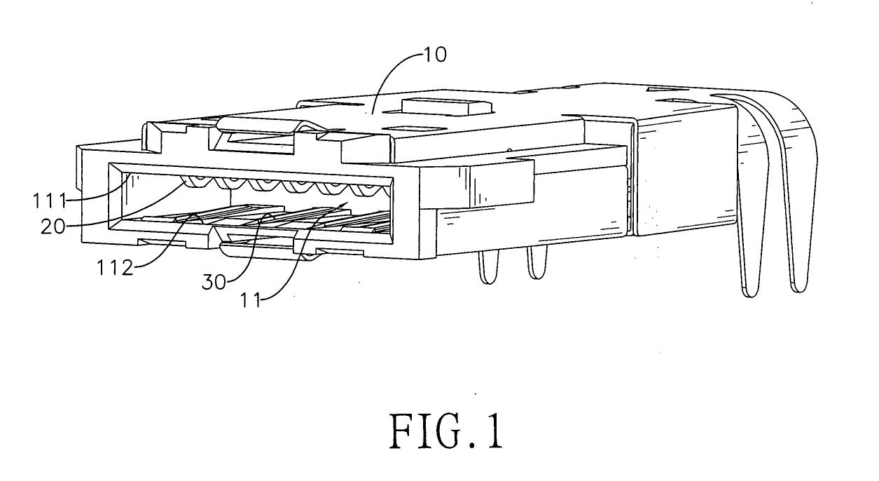

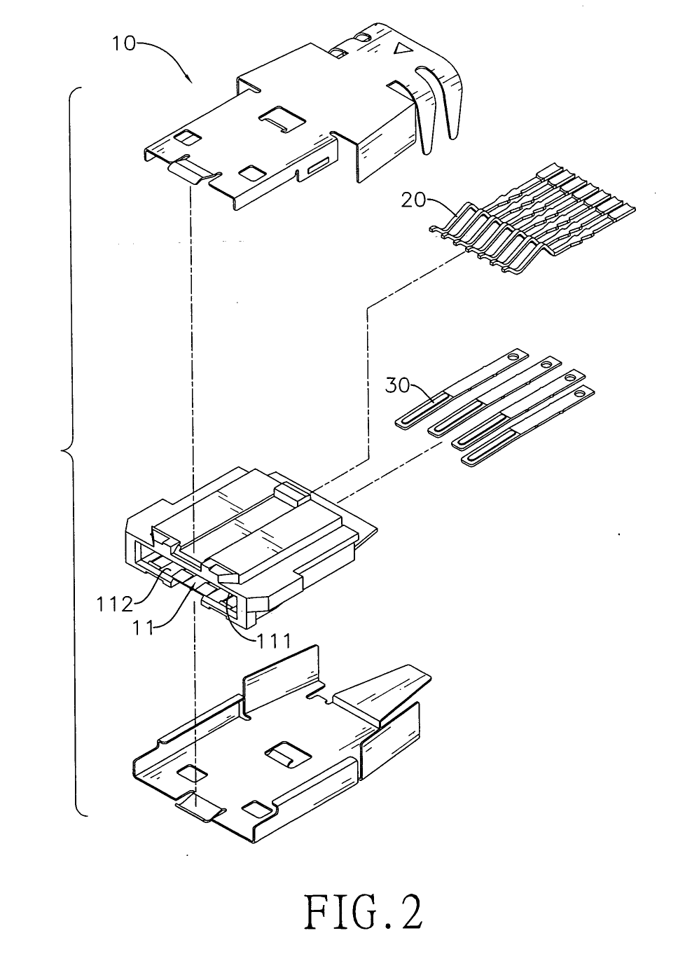

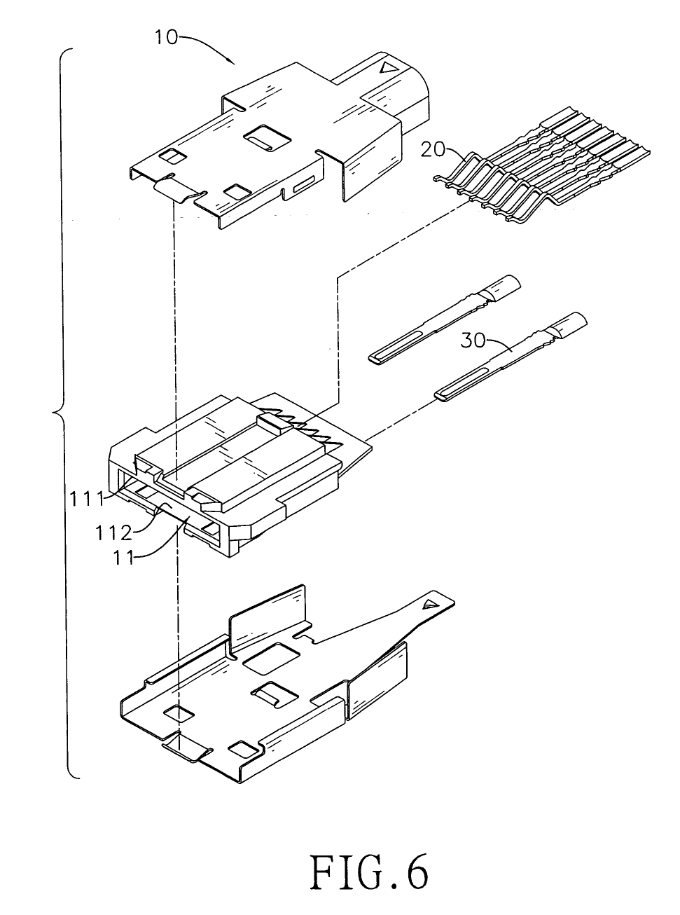

With reference to FIGS. 1, 2 and 6, an external serial advanced technology (eSATA) plug in accordance with the present invention is electrically connected to an external device such as a mobile phone, a personal digital assistant, a flash memory stick, a computer peripheral or the like to connect the external device to a personal computer, notebook or the like. The eSATA plug comprises a body (10), seven eSATA terminals (20) and a dual-purpose terminal assembly.

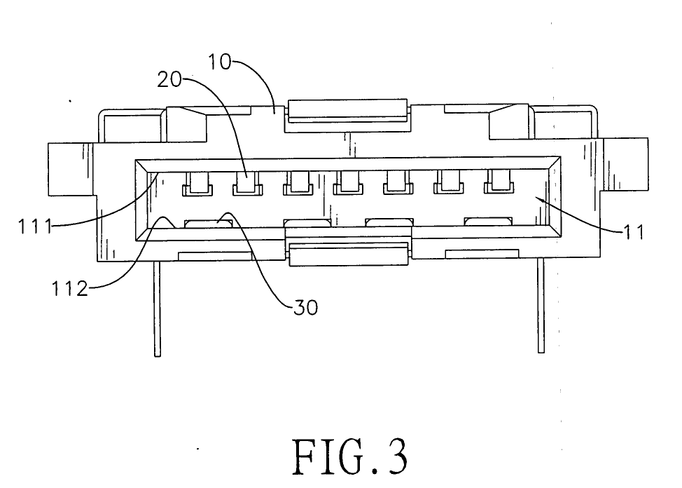

With further reference to FIG. 3, the body (10) conforms to the standards outlined for eSATA plugs and has a connecting end and a chamber (11). The chamber (11) is formed in and through the connecting end of the body (10) and has a first inner surface (111) and a second inner surface (112). The second inner surface (112) is opposite to the first inner surface (111).

The eSATA terminals (20) are mounted on and bulge from the first inner surface (111) of the chamber (11) and are arranged based on eSATA standards.

The dual-purpose terminal assembly is mounted on and bulges from the second inner surface (112) of the chamber (11). The dual-purpose terminal assembly comprises multiple power and data (P/D) terminals (30) being apart from and parallel to one another. Each P/D terminal (30) transmits either power or data. Four or two P/D terminals (30) may be implemented.

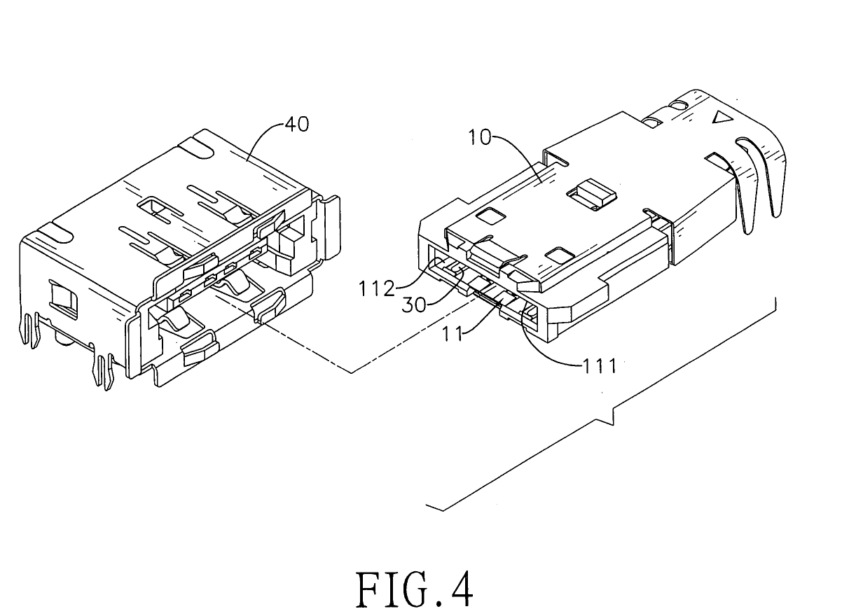

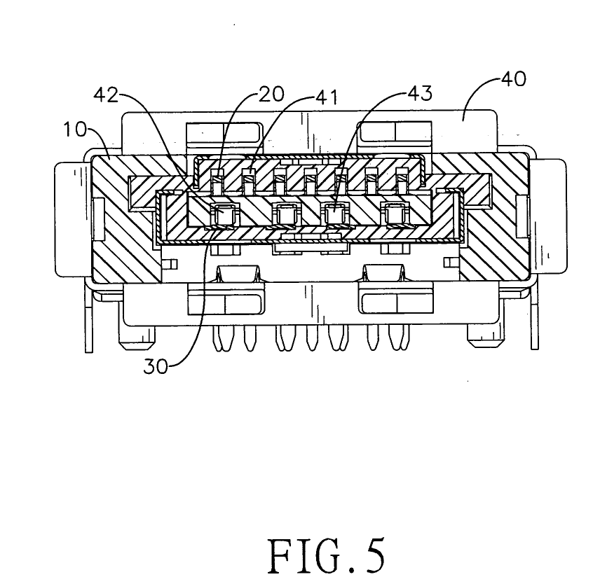

With reference to FIGS. 4 and 5, when the eSATA plug of the present invention is applied to an external device to connect to a computer having a 2-in-1 socket (40) conforming to eSATA and Universal Serial Bus (USB) standards, four P/D terminals (30) are implemented and conform to the USB standard. Based on the USB standard, the outer two P/D terminals (30) transmit electrical power and the inner two P/D terminals (30) transmit data. Further, the 2-in-1 socket (40) has seven eSATA contacts (41) and four USB contacts comprising two USB power contacts (42) and two USB data contacts (43). When the eSATA plug of the present invention is inserted into the 2-in-1 socket (40), the eSATA terminals (20) contact respectively with the eSATA contacts (41), and the P/D terminals (30) contact respectively with the USB contacts (42, 43). Therefore, the external device with the eSATA plug exchanges data with the computer over the eSATA terminals (20) and the eSATA contacts (41) and obtains electrical power from the computer over the USB power contacts (42) and corresponding P/D terminals (30).

Additionally, the four P/D terminals (30) may be all used to either obtain electrical power if the 2-in-1 socket (40) in the computer has seven eSATA contacts (41) and four power contacts, or transmit data if the 2-in-1 socket (40) has seven eSATA contacts (41) and four data contacts.

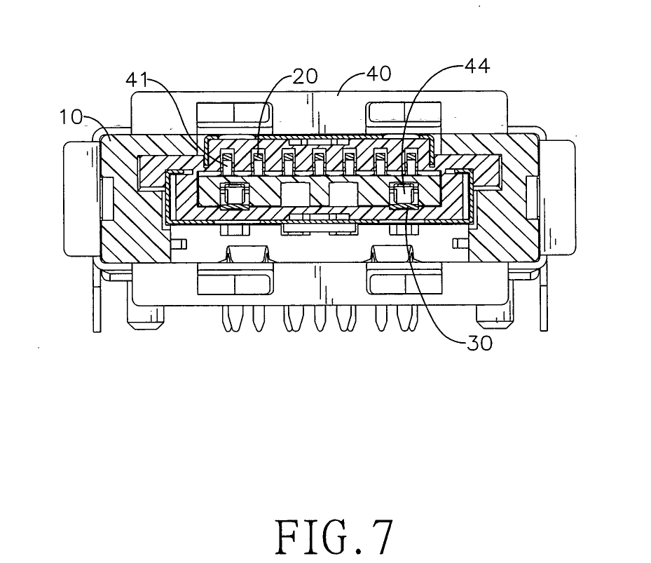

With further reference to FIG. 7, If the 2-in-1 socket (40) in the computer has seven eSATA contacts (42) and two power contacts (44), two P/D terminals (30) are implemented in the eSATA plug of the present invention to transmit electrical power. When the eSATA plug of the present invention is inserted into the 2-in-1 socket (40), the eSATA terminals (20) contact respectively with the eSATA contacts (41), and the P/D terminals (30) contact respectively with the power contacts (44). Therefore, the external device with the eSATA plug exchanges data with the computer over the eSATA terminals (20) and the eSATA contacts (41) and obtains electrical power from the computer over the two power contacts (44) and the two P/D terminals (30). Further, if the 2-in-1 socket (40) has seven eSATA contacts (41) and two data contacts, the two P/D terminals (31) may be implemented to transmit data.

The P/D terminals (30) in such an eSATA plug allow the external device to exchange data with the connected computer or obtain electrical power from the connected computer. The eSATA plug of the present invention provides more functions than a conventional plug disclosed in U.S. patent application with Publication No. 2005/0048846 and a conventional SATA socket disclosed in U.S. Pat. No. 7,255,607. The eSATA plug of the present invention applies to more applications than the conventional SATA plug or socket.

Even though numerous characteristics and advantages of the present invention have been set forth in the foregoing description, together with details of the structure and function of the invention, the disclosure is illustrative only. Changes may be made in detail, especially in matters of shape and arrangement of parts within the principles of the invention to the full extent indicated by the broad general meaning of the terms in which the appended claims are expressed.

What is claimed is:

1. A powered external serial advanced technology (eSATA) plug comprising:
a body having
a connecting end; and
a chamber being formed in and through the connecting end of the body and having
a first inner surface; and
a second inner surface being opposite to the first inner surface;
seven eSATA terminals being mounted on and bulging from the first inner surface of the chamber; and
a dual-purpose terminal assembly being mounted on and bulging from the second inner surface of the chamber, and the dual-purpose terminal assembly comprising
multiple power and data (P/D) terminals being apart from and parallel to one another, and each P/D terminal selectively transmitting electrical power and data.

2. The eSATA plug as claimed in claim 1, wherein four P/D terminals are implemented, conforms to Universal Serial Bus (USB) standard and comprises
two outer P/D terminals transmitting electrical power; and
inner P/D terminals being disposed between the outer P/D terminals and transmit data.

3. The eSATA plug as claimed in claim 1, wherein four P/D terminals are implemented and all transmit electrical power.

4. The eSATA plug as claimed in claim 1, wherein four P/D terminals are implemented and all transmit data.

5. The eSATA plug as claimed in claim 1, wherein two P/D terminals are implemented and all transmit electrical power.

6. The eSATA plug as claimed in claim 1, wherein two P/D terminals are implemented and all transmit data.
